(19) United States
(12) Patent Application Publication
(10) Pub. No.: US 2003/0200124 A1
(43) Pub. Date: Oct. 23, 2003

(54) Marriage insurance

(76) Inventors: Kristine Kiramittchian, Northridge, CA (US); Fares Hindash, Newark, CA (US)

Correspondence Address: Sanford Astor, Birch, Stewart, Kolasch & Birch, 18th Floor, 10940 Wilshire Blvd., Los Angeles, CA, 90024, US

(21) Appl. No.: 10/418,517

(22) Filed: Apr. 18, 2003

Related U.S. Application Data
(60) Provisional application No. 60/374,592, filed on Apr. 23, 2002.

(51) Int. Cl. G06F 17/60

(52) U.S. Cl. 705/4

(57) ABSTRACT

This invention comprises a method of doing business involving providing marriage insurance to parties of divorce (“dissolution” in some states) to protect them from financial difficulties as a result of a divorce, by providing benefits including, cash payments, and emotional, legal and financial planning assistance.

This invention is described in our U.S. Provisional Application No. 60/374,592, filed Apr. 23, 2002.

### FIELD OF THE INVENTION

This invention comprises a method of doing business involving providing marriage insurance to parties of divorce (“dissolution” in some states) to protect them from financial difficulties as a result of the divorce.

### BACKGROUND OF THE INVENTION

No matter how careful we are, or how much we think ahead, life is often unpredictable. Life is all about change. As we move throughout the stages of our lives, our priorities change and therefore our need for security and protection may also change.

Marriage and divorce are two of the most important emotional and financial events in a person's life. Marriage is a unique system, but divorce is also a fact that cannot be denied and it can happen to anyone. Divorce is the second major cause of single-parent families, and Americans divorce at the highest rate among all nations of the world.

The phenomenon of divorce is a far more complex issue than generally believed. Furthermore, statistics pertaining to divorce are difficult to understand and as a result, are frequently misinterpreted. Parents often misunderstand the effects of divorce on children and underestimate the financial consequences associated with it, that can lead mothers and children into poverty for the rest of their lives.

Family researchers have found that it is not the divorce itself that creates long-term disturbance in children, but other significant factors related to post-separation changes. The most important factor is the financial quality of post-separation life of children and how they are propelled into poverty due to financial hardship.

Whether or not divorce is the best answer for a particular family situation, it is the parent's responsibility to provide the adequate financial support for their children throughout the trauma of divorce.

Divorce has grown significantly over the past half century. Yet official government statistics on marriage, divorce, and correlates in child outcomes are being gathered and reported less frequently. In fact, statistics on marriage and divorce are no longer tracked in at least half of the states today. Some of the actual statistics on divorce nationwide are:

Divorce rate is predicted to reach about 40-52%.

The most vital decision in a divorce is always related to post-divorce financial issues.

Estimated average length of divorce proceedings is 1 year, and this excludes any child custody battle and child support arrangements, which may take several years.

Estimated average cost of a divorce is $15,000.

An estimated 1,750,000 children are involved in divorce each year.

90% of the time, custody is granted to mothers.

The percentage of children living with custodial mothers who earn under $12,000/year is 41%.

Women initiate divorce at a rate 3 times that of men. The more financially independent the women, either from their earnings or from child/or spousal support, the greater the chance of divorce. During economic boom times, divorce increases. During recessions, it decreases.

The average age at first divorce is between 33-35.

Average duration of marriage is 7-10 years.

22% of all divorces occur within the first 3 years.

38% of all divorces occur within the first 5 years.

65% of all divorces occur within 10 years.

90% of all divorces occur within 20 years.

There are 2.5 million people divorced each year.

The census bureaus project that 40-60% of second marriages will end in a second divorce.

Divorced women who get custody of their children suffer a 35-45% decline in their standard of living in the first years after divorce. On the other hand the father's standard of living increases by 10-15%.

On average, it takes divorced women about 6-18 months to get awarded any kind of support (child or spousal).

Of these women, 34% never receive a penny of what is due to them.

Less than half of all women awarded child support ever get the full amount.

52% of all divorced fathers hardly visit their children after the second year of divorce.

Only about 50% of divorced fathers pay child support regularly, 25% pay sometimes, and 25% pay little or nothing at all.

Only 58% of the 10 million women with children under 21 have child support awards.

The average amount of yearly child support received in 2001 was $2,995.00.

Of the 12.8 million cases handled by government child support enforcement agencies, only 18% received a collection.

The government collected less than $615 million of the $6.8 billion due in back child support.

40% of men and women who divorced in their 20's are struggling financially 10 years later. This is probably because they married in their teens, had children, missed college, and now have support payments (child or spousal).

Of the 18 million poor children in this country, over 50% live in a single parent home.

Over 25 million children are owed over $60 billion in court-ordered child support payments by absentee parents

Studies show that states highest in child support and welfare payments, rank lowest in child well-being.

Divorce is a direct cause of poverty for a large proportion of women and children. Many will experience the consequences of poverty in the short term following divorce, and many will suffer its effects for many years ahead. Divorce is very dramatic for mothers and their children. It could be the most painful and expensive experience they face together. In fact, the hardest divorces come when the divorcee is surrounded with endless financial obligations.

In the event of divorce, single mothers must be prepared for some major financial changes, especially in the first years after divorce. Some of these changes might not be pleasant. The income and assets that once supported one household must now support two.

Under our present policies and procedures, divorce is widely quoted by family service professionals as the greatest single predictor of poverty for women and children. Recent studies state that 91% of single parents are women, most of them divorced with children, and single parents have now been named as the poorest group of people in the country.

Women's poverty rises from 16% before divorce to 43% after divorce. Even three years after divorce, women's income remains far below what they had during marriage and far below their ex-husbands' income.

Poverty associated with the divorce is not because of the divorce itself, but because of two significant factors:

1—Issues associated with the divorce process that may drain women and children financially and pull them into poverty after divorce.

2—Lack of financial support and limited financial resources for women and children, especially in the first years after the divorce is finalized. The financial situation of women in the first years after divorce is documented to be the main factor in determining whether or not divorced women and children fall into poverty in the years ahead. Most of the financial burden occurs in the first five years following a divorce. In these critical years, single women with children face unlimited financial challenges.

Issues Associated With a Divorce:

Many mothers and their children have been propelled into poverty at the time of divorce because of many issues. These issues include:

Debt occurring during the marriage and during divorce; emotional issues, which may require counseling; legal issues often involving great expense; unreliable child and spousal support payments; income reduction often due to lack of job skills; health insurance issues; child care costs; low welfare payments; child custody issues; domestic abuse issues and limited financial resources after divorce.

Divorce reduces the income of families with children by an average of 42 percent, and almost 50 percent of these families live in poverty. Following a divorce, a woman's standard of living drops an average of 40% annually while a man's rises 10%. This is due to a lack of financial resources and lack of financial support after divorce.

Divorce has significant negative economic consequences for families. The breakup of families leave single mothers trying to do the work of two people and one person cannot support a family as well as two can. Women earn less money than men after divorce, even when they are in the same occupation. The average women's income after divorce is not enough to pull them out of poverty. Debt often occurs during marriage or during divorce, including house payments, credit cards bills, and childcare obligations. Childcare means that women have less time to spend on their work, which means less income.

### Government Services

Child support enforcement has been one of the government's most difficult assignments. The federal welfare reform legislation of 1996 gave state child support enforcement agencies many tools that have helped improve child support collection.

In 1996 the government child support enforcement program collected an estimated $12 billion in child support payments, but the caseload on the government workers is so overwhelming that it's no longer manageable.

The facts demonstrate that over the past 20 years, federal and state funds for child support enforcement have been inadequate. Across the nation, eight out of ten (80%) custodial parents who have applied for child support enforcement services do not receive any payment from the absent parent.

According to government officials, government offices are overwhelmed by a backlog of more than 19 million cases, shortage in funding, and lack of personnel.

Millions of families are going without help. That's why the private collection agency business has soared to a $75 million level in the last 5 years.

### Private Services

Private child support collection agencies offer alternative to existing government programs and private attorneys. They are licensed and bonded as collection agencies. They have the ability to operate in fifty states. The collection staff is trained and certified.

Divorced mothers turn to these private agencies to speed up the process of collection of the child support money owed by their ex-husbands.

Private agencies usually charge between $20-50 for an application fee, and $100-300 in processing fees in advance.

These agencies collect 25-35% of the entire child support amount that they collect.

These agencies often only accept cases where ex-husbands owe $5000 or more.

After an agency accepts the case, it might take another 1-3 years (or more) to locate the father and collect from him. The agency even might not be able to collect if the father is in jail or disabled or outside the country. Mothers in this case lose their application and processing fees.

### SUMMARY OF THE INVENTION

This invention comprises Marriage Insurance which is the solution that will protect women and children from falling into poverty after divorce. It replaces partially or completely the second income for the family. Protection is the main reason for women to consider having a marriage assurance plan. Marriage Insurance provides adequate financial support “cash value”/“divorce proceeds” for women and children in the first years after divorce, which are documented to be the most critical time for the whole family.

In order for the marriage insurance concept to be economically rewarding and socially acceptable at all stages of life, marriage insurance has to offer more than just cash benefits; it has to provide financial, social, and legal services and the support that is needed to help women and children get out of poverty in the very first years after divorce. At all stages of life, divorced men and women will need the help of professional services, such as, but not limited to:

Social Counselors, pre-marital and post-marital counselors.

Financial Planners.

Divorce Attorneys.

Mediators and divorce planners.

Accountants and adjusters.

Insurance agents.

Childcare providers.

Child support collection agents.

Match making services.

Marriage Insurance is developed to provide most of the financial, emotional, and legal support that women might need during their marriage or due to a divorce.

Marriage Insurance is designed to be a one-stop shop for single, married or divorced men and women. It enhances the quality of life of men, women and children by protecting them from poverty at any stage of life. Marriage Insurance provides most of the financial, social and legal resources that are needed by single, married, or divorced men and women at any stage of life.

Marriage Insurance is the ultimate resource for men and women thinking about either ending their marriage, rebuilding their marriage, or starting their marriage. Whether they are looking for a financial planner, mediator, marriage counselor, divorce attorney, or insurance agent, marriage insurance can help them find the people and services they need.

Marriage Insurance is dedicated to providing men, women, and children with comprehensive financial and emotional support after divorce that enables them to enjoy financial freedom at all stages of life, especially in the post-divorce stage of life, where extra financial support is needed. A key function of marriage insurance is to protect the financial future of women and children after divorce. Marriage Insurance provides financial security “Cash benefits” after divorce plus a full line of emotional, legal, and financial planning services all in one single plan.

The reasons for purchasing marriage insurance include replacing the second income of the spouse and helping family members survive the financial and emotional burden of the dissolution of their marriages. Other marriage insurance benefits include income to cover all day-to-day expenses.

In the event of divorce, a custodial parent may be unable to work but the bills keep coming in. Marriage insurance proceeds could be used for mortgage protection, credit card debt, bank loans, or even income replacement during the very difficult time that is ahead. Marriage insurance proceeds would generally be used to maintain the financial quality of life of an individual “mostly women and children” in the first years after divorce.

### OBJECTS OF THE INVENTION

It is an object of this invention to create a business method comprising providing Marriage Insurance to provide most of the financial, emotional, and legal support that women might need during due to a divorce.

It is a further object to provide Marriage Insurance, designed to be a one-stop shop for single, married or divorced men and women.

Yet another object is to provide a business method to enhance the quality of life of men, women and children by protecting them from poverty at the time of a divorce.

### BRIEF DESCRIPTION OF THE DRAWINGS

FIG. 1 is a rate chart for a marriage insurance policy.

### DETAILED DESCRIPTION OF THE INVENTION

How marriage insurance works:

After dissolution of a marriage, while the marriage insurance contract is in force, the insurance provider pays a specified sum of money, “cash benefits” “divorce proceeds”, to the designated beneficiaries.

Marriage insurance coverage periods range from a specified period of time or may last for a lifetime.

Marriage insurance policies pay beneficiaries the face value; “The amount stated on the face of the marriage insurance policy, to be paid in the case of divorce”. If the insured divorces during the term, for example, a 10-year term policy with a face value of $50,000 would pay $50,000, if the insured divorced at any time during those 10 years.

At the end of the term, the insured is no longer insured, and divorce benefits are not paid. Some marriage insurance plans are renewable or can be converted to a permanent marriage insurance plan.

Besides the “cash benefits”, marriage insurance provides insureds with emotional, legal, and financial planning services both during the policy time and in the first years after divorce, to help maintain healthy living standards.

Men and women can purchase Marriage Insurance at different stages of life, “single” or “married”.

A Marriage insurance policy can be purchased individually or as a part of a package that contains life insurance or any other insurance. There can be one policy that provides financial security in case of divorce or death.

Combining marriage insurance with life insurance will add great value to any life insurance policy. This will add an increased customer base and develop new markets, and will add business to any life insurance company.

### Policyholders

Policyholders are mainly women at all stages of life, single, married, or divorced. Men that expect to have custody of their children may purchase this type of insurance as well. Parents may also buy this type of insurance for their children.

### Beneficiaries

The spouse (mostly women) who is expected to gain custody of the children and be the receiver of alimony or child support is the ideal beneficiary of marriage insurance. In the event of joint custody, and with pre-arrangements, both parents can benefit equally from all the benefits.

In general, beneficiaries are:

A woman or man who takes on the financial burden of raising the children alone.

The spouse who is entitled to alimony or child support.

Parents can name their children as the beneficiaries (in some cases).

### How Much Does Marriage Insurance Cost

Many options are customized to fit different needs and budgets. The actual cost of the policy coverage depends on, but is not limited to, a number of factors:

Divorce rate in the state where policyholder resides.

Marital status, single, married, or divorced.

Number of children.

Coverage amount.

Age of policy holder, age of spouse, age of children.

Occupation

Length of marriage.

Previous divorce history.

Length of time during which covered benefits would be available.

Length of waiting period “marriage evaluation period” if any.

Specific policy features and benefits that policy owners select.

Other risk factors.

The policy issuer has the right to raise future premiums by state, policy features and benefits.

Certified underwriters and actuaries will decide upon the final cost of different types of policies. Policyholders can purchase marriage/divorce insurance policy in a one lump-sum payment. However, in most cases they can pay the premiums over three, five, or ten years. Payments may also be made on an annual, semi-annual, quarterly or monthly basis. Payment plans also depend on what options are included in the policy.

### Coverage/Benefit Amounts—“Face Value of the Policy”

Coverage amounts or divorce proceeds may be increased gradually with length of marriage, “Divorce graded benefits”. The longer the marriage, the bigger the payout.

### Coverage Amount Depends on Several Factors

Marriage period.

Debt obligations.

Number of children.

Household income.

Standard of living.

Policy features and benefits.

Cash benefits could be paid to beneficiaries in one lump-sum payment or in extended monthly payments.

Each woman's needs are different and needs change at different life-stages. Marriage insurance provides comprehensive financial planning services.

Cash management: budgets, credit, financial goal-setting or debt consolidation.

Tax Planning: reduction strategies, deductions and exemptions, children's income, liability.

Risk Management: health insurance, long-term care, disability insurance, homeowner's insurance, auto insurance, life insurance.

Investment Planning: sources of income, savings goals, social security, retirement plans.

Estate Planning: property ownership, protection of dependents.

Pre-Divorce Planning: determine financial position before divorce, financial awareness during divorce, goal setting, and analysis of property settlement options.

College Investment Planning: source of funds, analysis of needs.

Property Management: buy or rent home, lease or buy automobile.

### Insurance Coverage Services

Although insurance is designed to provide security, it can be one of the biggest causes of insecurity at all stages of life, especially during crises such as death and divorce.

Marriage insurance is designed to provide insurance coverage assistance to women at all stages of life single, married or divorced (health, dental, vision, car, and home), and provide them with honest and adequate advice to help them get the most for their money, without taking advantage of their situation.

One of the most important issues in a women's life is health insurance. Dealing with health insurance is probably not at the top of a woman's “to do” list when going through a divorce. However these are important issues that need to be handled carefully, especially if custody of children is involved.

After divorce, all mothers face two kind of insurance coverage that needs to be addressed; physical health coverage and mental health coverage.

### Physical Health Assistance Coverage

In case of divorce, the wife is usually removed from the husband's health plan. The husband needs to provide a proof of divorce before any adjustments are made. Fortunately, the wife in this scenario will not necessarily find herself without health insurance. COBRA will cover her.

COBRA acts like a safety net for folks going through rough times: death, divorce or unemployment. It guarantees that the wife can buy 36 months' worth of health coverage. The husband needs to notify the insurance carrier that he wishes to set up COBRA benefits for his ex-spouse.

In this case, the ex-wife has to pay the full cost of the premium plus the monthly payment if she decides to accept COBRA coverage. Since COBRA benefits are costly and meant to be short term, the wife may want to consider securing another health care provider. The wife may want to buy private insurance.

### Mental Health Assistance Coverage

After divorce, and when informative counseling is not satisfactory, mental therapy is required. Mental health services may be covered by regular health insurance.

Insurance coverage for therapy varies widely in the number of sessions allowed, co-pay per session, and the deductible to be met before the insurance pays any amount.

Marriage insurance makes sure that women keep their insurance benefits even after divorce, provides single, married, or divorced women with precise and adequate resources of insurance coverage and makes sure that they get maximum benefits for their money without being overcharged or taken advantage of.

Marriage insurance provides the following:

Full description of the best insurance provider that fits the exact financial budget and type of services needed for every woman, single, married, or divorced.

Advisory assistance to help women be aware of how important it is to choose a health insurance plan that covers mental therapy as well.

In case therapy is needed and the insurance plan does not cover it, counselors negotiate the fees for all members to help them get the lowest prices for treatment.

### Informative Social Counseling Services

Divorce often begins with pain. For many, there is a sense of sadness and a sense of helplessness. These feelings can be caused by the nature of physical and emotional separation. For most couples, the pain and sadness can reach extraordinary levels. Divorce often starts with a period of mourning. Sadness can be accompanied by guilt and anger.

Marriage Insurance provides access to effective informative counseling which can help transition through this difficult period by allowing the full range of emotions to be expressed. During this time and when children are involved, counselors will provide support and encouragement for both parents. The counselors will provide valuable advice on how a divorced couple should handle their finances, emotions and try to recover and start new lives.

Counseling can be provided over the phone. If counseling received over the phone is not satisfactory and therapy is required, counselors will provide a referral for face-to-face counseling.

Marriage insurance does not provide therapy. Instead, it provides advice to choose health insurance that covers therapy. It helps find the best insurance companies that cover therapy.

Marriage insurance services focus on providing women with general informative emotional, financial and legal counseling that they need on a daily basis. This will be accomplished by offering:

Informative phone counseling; one-on-one by arrangement

Divorce educational seminars and marriage workshops. Monthly seminars and workshops will cover many topics including communication, conflict resolution, financial management, mediation, and legal issues. These seminars and workshops will stimulate discussions about situations, events, or issues that face single, married or divorced women in today's society.

Online interactive chat rooms.

### Informative Legal Counseling Services

Most marital legal problems arise at the end of a marriage. Divorce law can be legally complicated and very contentious, especially if the couple has substantial property or children.

The cost of divorce can be staggering. Litigated divorces may take years and cost thousands of dollars, which may affect the quality of life after divorce for mothers and children.

Marriage insurance provides informative legal assistance and follow-up at as reasonable a cost as possible.

Marriage insurance focuses on:

Preparing women in an informative way, whether they are single, married or divorced, to deal with any legal issue, and be prepared for any emergency situation that might come their way.

Educating women about important issues associated with divorce such as; custody, visitation, fault, division of property, alimony, and child support.

Providing women with a detailed, honest and adequate legal evaluation of any divorce case.

Providing parents with mediation and accounting assistance if needed.

Making sure that a beneficiary's rights are protected during the divorce process.

Making sure that one spouse will not take advantage of the other spouse, emotionally or financially.

Providing a large database of attorneys, accountants, and mediators across the country.

Marriage insurance provides the following:

Marriage insurance provides child support collection services free of charge for its members, no application or processing fees. It charges only 10% of what is collected for monitoring the flow of payments from non-custodial parents.

With marriage insurance, there will be no waiting period for mothers and children and no accumulation of a certain amount of money before the collection procedures are started. Marriage insurance starts paying as soon as the divorce is finalized. This gives mothers and children the financial freedom they require, even before collecting from non-custodial parents.

This service helps to adjust the transition from the old family to a new and divorced family; this adjustment requires a lot of time and effort. At this point the husband and wife are undergoing emotional stress and the last thing they want to worry about is money or fighting over child support payments. Knowing that there is no battle over child support payments when the divorce is filed, the couple might heal emotional problems faster and in a better way that is best for the children involved.

Marriage insurance provides some advantages to non-custodial fathers involved in a divorce by giving them a break for some time so that way they can gather themselves as well.

Non-custodial fathers can be assured that they will not be rushed into paying child support or alimony within the first year after divorce. They can rely on marriage insurance to help them out during these crucial times.

Marriage insurance is great for fathers to buy. It gives fathers peace of mind in case of divorce. In case they need some extra time before they start paying child support payments, children will not suffer financially during this time.

During the first year after divorce, marriage insurance makes sure that it starts the initial collection procedure by keeping track of the father's locations and employment history, but the actual collection process may not start until after the first year of the divorce.

### Childcare Services

According to the childcare information exchange trends 2000 report, childcare is a $35 billion industry. There are more than 110,000 licensed childcare programs in the United States serving more than 6.5 million families.

According to the U.S labor Department, there will be more than 44 million working mothers by the year 2002.

But quality of life after divorce is different. Lack of financial resources for divorced mothers forces them to put their children in poorer quality daycare centers to save money.

The main source of income for mothers after divorce is work. With or without a job, mothers without quality childcare benefits from their employers or from the government, cannot lift themselves or their children out of poverty.

Women have shown the desire to work rather than be on welfare, to support their children after divorce. Mothers with school-age children have one of the highest workplace participation rates in the country.

These women have often been left out because a key factor affecting a single mother's employment is the high cost of childcare. The result is that there is a high rate of single parent unemployment.

Once single mothers enter the job market, they tend to stay working and improve both their own and their children's lives.

Quality childcare with reasonable rates is very important to improve the quality of life for women and children. Marriage insurance provides quality childcare assistance/referrals to women and children at all stages of life, single, married, or divorced

This service primarily includes a referrals program to well-trusted childcare providers. The purpose is to bring childcare providers and childcare seekers together.

Marriage insurance provides a low-cost online directory of Family Child Care Providers that is valuable for both providers and parents. This directory service is provided at a very low cost, such as $19.95 per year. Top family childcare professionals will help monitor and contribute to the directrory. This service will be monitored by a Child Care Professional Site Advisor.

The Marriage insurance concept will have a huge impact on the community by:

Easing the pressure on the welfare office, which will save taxpayers a lot of money.

Helping mothers and children get out of poverty after divorce.

Reducing divorce rates in some cases.

Insuring that the non-custodial parent will not walk away from the children in the first years after divorce.

Increasing marriage rates by women who have been holding back from getting married because of what are they expecting to face in case of divorce.

Helping mothers to spend quality time with their children in order to prevent the children from becoming out of control.

Various products are offered by marriage insurance:

### Product 1

### For Married Couples

This is the basic product offered by the marriage insurance plan. This plan benefits the custodial parents (he or she) by giving them access to cash immediately and on an ongoing monthly basis, and also benefits the non-custodial parents (he or she) by alleviating their financial obligations to pay alimony and child support during the benefit period.

With this product, the wife and the husband will know that their children are protected and provided for in case of divorce. By not having to worry about the financial consequences after divorce, they both can re-establish themselves and start their lives over again with confidence.

Assuming that the mother gets custody of the children the terms are as follows:

Upon the break up and dissolution of the relationship, the wife (custodial parent) receives:

1. A monthly cash benefit of a specified amount and a specified length of time (benefit period) and/or

2. An immediate cash benefit to assist with expenses related to the dissolution process.

Upon the break up and dissolution of the relationship, the husband (non-custodial parent) receives:

1. An agreement from the wife that she will waive the right to receive alimony during the benefit period.

2. An agreement from the wife that she will waive the right to receive any child support payments during the specified benefit period (if allowed by the law of the state).

Options

1. Upon agreement, in some marriage insurance plans, the husband will be responsible for paying a co-payment for the marriage insurance policy. By law, the non-custodial parent is obligated to pay alimony and child support. Instead, during the benefit period, the husband will pay only the co-payment amount, which is a fraction of what he is supposed to pay in support. This will have a very positive impact on the husband's financial situation right after the divorce. It will keep the husband around his children without running away from them, trying to avoid paying the child support. In other words, the non-custodial parent will pay a co-payment instead of the full child support or alimony required.

2. The custodial parent may have the option of proceeding with a court child support order against the non-custodial parent if the non-custodial parent refuses to pay the co-payment for the policy. The insurance company may have the exclusive right to collect from the non-custodial parent, upon request, unless otherwise noted in the policy agreement. In other words, the insurance company will get an irrevocable authorization to collect child support payments from non-custodial parents.

3. The policy may require that benefit period will last until the children reach the age of 18 so the non-custodial parent will not have to pay any child support. This of course, will increase the premium of the insurance policy.

### Product 2

### For Concerned Spouses (Primarily Wives, But Also Some Husbands)

This type of marriage insurance plan can be purchased by the individual (wife or husband) who wants to plan for the unfortunate event of a break up and divorce. For this “marriage/divorce insurance” product, there will be only one owner of the insurance policy; there will be only one beneficiary or insured; and the insured may or may not be the person who gains custody of the children.

Upon the break up and dissolution of the relationship, the beneficiary (wife or husband) receives:

1. A monthly cash benefit for a specified amount and specified length of time (benefit period) and/or

2. An immediate cash benefit to assist with expenses related to the dissolution process.

Upon the break up and dissolution of the relationship, the non-beneficiary may receives:

1. An agreement from the beneficiary that he or she will waive the right to receive any alimony during the benefit period.

2. An agreement from the beneficiary that he or she will waive the right to receive any child support payments during the specified benefit period (if legal).

Options

1. If the owner of the policy becomes the custodial parent, he or she can choose to hire the company as the primary collection agency for the purpose of making sure the non-custodial parent pays the awarded alimony and child support payments.

### Product 3

### For Single People (Who Are Planning Ahead)

This “marriage/divorce insurance” plan can be purchased by both single men and women who are planning ahead for the unforeseeable and unfortunate case that their marriage in the future does not work out and a divorce occurs.

By owning this “marriage/divorce insurance” product, people can enter into marriages without worrying about the financial hardships and stresses that may occur in the case of a divorce. For this “marriage/divorce insurance” product, there will be only one owner of the insurance policy; there will be only one beneficiary or insured.

The longer a person pays into this insurance product, the longer their marriage will be covered. For instance, if they purchase 5 years of coverage before their marriage, their marriage will be covered for five years, etc.

Upon the break up and dissolution of the relationship, the beneficiary receives:

1. A monthly cash benefit for a specified amount and a specified length of time (benefit period) and/or

2. An immediate cash benefit to assist with expenses related to the dissolution process.

Upon the break up and dissolution of the relationship, the non-beneficiary may receives:

1. An agreement from the beneficiary that he or she will waive the right to receive any alimony during the benefit period.

2. An agreement from the beneficiary that he or she will waive the right to receive any child support payments during the specified benefit period (if legal).

Options

1. The insured can choose to plan for the possibility of becoming the custodial parent, if children are involved. The custodial parent can choose to hire the company as the primary collection agency for the purpose of making sure that he non-custodial parent pays the awarded alimony and child support payments.

2. In exchange, the non-custodial parent can avoid paying child support or alimony payments in the benefit period, by agreeing to pay the co-payment amount for the marriage insurance policy.

### Product 4

### For Parents (Who Want To Provide For Their Children's and Grandchildren's Well Being)

The parents purchase this type of marriage insurance for their children. It is especially designed for young adults and it is a practical answer for parents who give an extra measure of care and thought to their children's future financial security. This insurance product is intended to supply the extra financial security at a time when adult responsibilities are likely to begin, but when income may be limited. Parents often feel obligated to help their teenage children who might get into marital difficulties and get divorced at a young age. Parents may need to help support their children financially in cases where a child is going through marital difficulties, getting divorced, or transitioning from marriage into a single life, because their child and their grandchildren may be going through financial hardships and stresses resulting from their break up. In these instances, the added financial burdens can also cause financial hardships and stresses on the parents. Therefore, investing in the Marriage Assurance & Maintenance Plan on their children's behalf is a smart financial decision.

This “marriage/divorce insurance” policy can be purchased by parents of single or married children in order to plan ahead for the unforeseeable and unfortunate case that their children's marriages do not work out and a divorce happens. By owning this “marriage/divorce insurance” product, parents and their children will have financial peace of mind when their children enter into marriages, without worrying about the financial hardships and stresses that may occur in the case of a divorce. For this “marriage/divorce insurance” product, there can be several owners of the insurance policy—the parents and the children. Thus, there will be several beneficiaries or insured's (also, the insured may or may not be the person who gains custody of the children).

It has been noted that 65% of teenage marriages end in divorce. This alone leaves a toll on society and the community. These marriages often produce children as well, leaving the children with very young and unprepared parents. Once the couple had divorced, the husband may still be a teenager who cannot find a job and cannot afford to pay child support or alimony. If he does have a job it will be an average paying job, considering his age, education and experience in life, this will lead to a child support check under a few hundred dollars a month.

The young girl's parents may well support her and their grandchild or grandchildren. Which will cause financial difficulties within their own home. They may or may not be able to support them, as they would like. This may leave the mother alone, with the responsibility of raising the children on her own. Considering her age, she might need to drop out of school to support her child or children, which will lead to a lower chance of her and her child ever having a good life, because she will be lacking education. This will have a negative impact on the community and society surrounding her.

This type of marriage insurance policy will help parents provide for their children, especially their daughters, because daughters most of the time end up being the custodial parent.

Parents can buy this policy for their children before marriage even when they are teenagers, or at a very young age. If the child divorces before the age of 18, or 21 in some states, the parents will be the beneficiaries of the proceeds unless otherwise noted in the policy application. The parents or the beneficiary have the option to transfer the policy ownership to their children when the child turns 18 or 21. The son or daughter will become the beneficiary of the policy. This will help the community and it will help parents to not have to struggle to support their teenage children in case of divorce.

Upon the break up and dissolution of the relationship (if the beneficiary is under age), parents receive:

1. A monthly cash benefit for specified amount and specified length of time (benefit period) to support their child's lifestyle and the lifestyle of their grandchildren. And /or

2. An immediate cash benefit to assist with providing for the needs of their child's household and the needs of their grandchildren or any expenses related to the dissolution process

Upon the break up and dissolution of the relationship, (if the beneficiary is over legal age) beneficiary receives:

1. A monthly cash benefit for a specified amount and a specified length of time (benefit period) to support their child's lifestyle and the lifestyle of their grandchildren; and/or

2. An immediate cash benefit to assist with providing for the needs of their child's household and the needs of their grandchildren and/or any expenses related to the dissolution process

Option

1. At age 21, the child becomes the policy owner and the benefits automatically transfer to him or her.

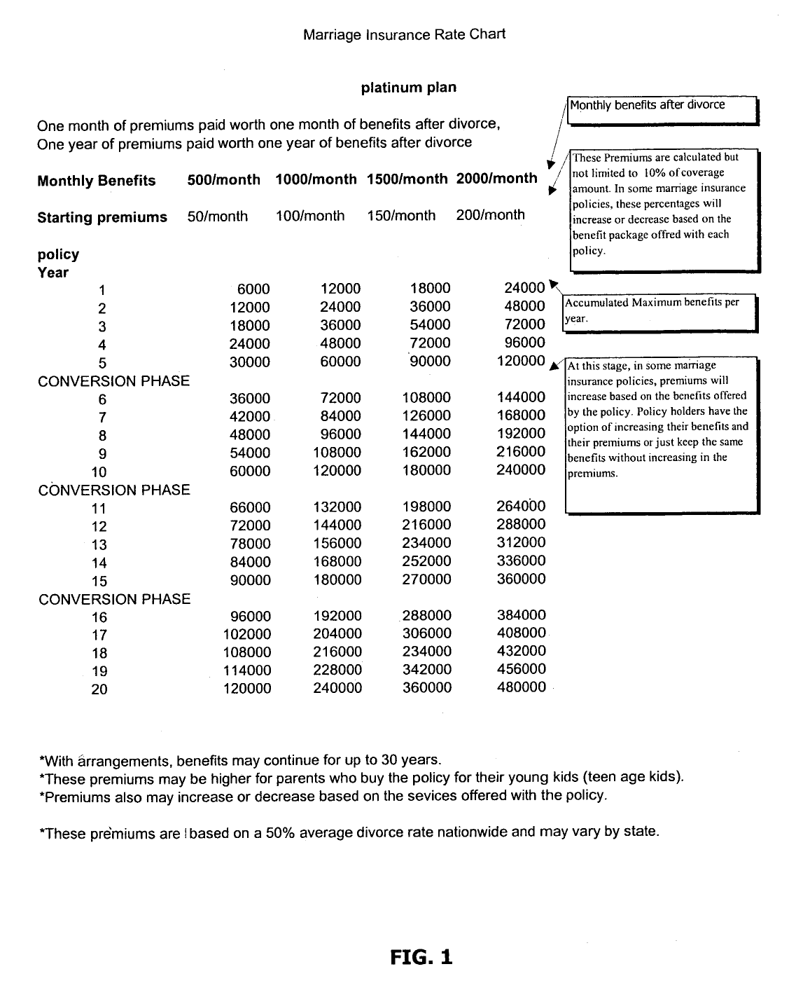

FIG. 1 shows a sample rate chart in which the monthly premiums are compared to the policy year, to show the benefits which will be paid under the policy.

Having thus described the invention, we claim:

1. A method of doing business comprising selling marriage insurance policies to policy holders, for which they pay an insurance premium, which insurance provides benefits upon the policy holder becoming divorced, comprising one or more of cash payments, and health, emotional, legal and financial planning assistance.

2. The method of claim 1 in which the cash benefits are paid in a lump sum.

3. The method of claim 1 in which the cash benefits are paid in periodic payments.

4. The method of claim 1 in which the marriage insurance is combined with life insurance.

5. The method of claim 1 in which benefits comprising one or more of social counselors, financial counselors, legal counselors, health counselors, insurance agents, childcare providers, collection agencies and match-making services are provided.

6. The method of claim 1 in which the benefits are paid to the policy holder.

7. The method of claim 1 in which the benefits are paid to beneficiaries named by the policy holder in the insurance policy.

8. The method of claim 7 in which the beneficiaries are the policy holder's children.

9. The method of claim 1 in which the policy holder is either single or married.

10. The method of claim 1 in which the insurance premium is determined by underwriting factors comprising marital status, number of children, age of policy holder, age of children, age of spouse, coverage amount, length of marriage, previous divorce history, occupation, length of time during which covered benefits are available, length of time before benefits commence.

11. The method of claim 1 in which the policy premium is paid in a lump sum.

12. The method of claim 1 in which the policy premium is paid in periodic payments.

13. The method of claim 1 in which there is an initial waiting period during which no benefits are paid.

14. The method of claim 1 in which benefits are not paid until a final judgment has been rendered in the divorce.

15. The method of claim 1 in which the premiums for the policy are based upon one or more of the divorce rate in the state in which the parties reside, marital status, number of children, age of the policy holder, age of the spouse, age of the children, length of marriage, occupation, previous divorce history, coverage amount, length of time of benefits, length of initial waiting period and type of benefits of the policy.

16. The method of claim 1 in which the amount of coverage purchased is determined by the purchaser of the policy based upon the length of the marriage, debt obligations, number of children, age of the policy holder, age of the spouse, age of the children, household income, standard of living and the policy features and benefits.

17. The method of claim 1 in which the policy is designed for married couples.

18. The method of claim 1 in which the policy is designed for single people.

19. The method of claim 1 in which the policy is designed for a person's children or grandchildren or both.

20. A marriage insurance policy which provides benefits to policy holders in the event of divorce, for which they pay an insurance premium, in which the benefits comprise one or more of cash payments, and health, emotional, legal and financial planning assistance.
